(19) United States
(12) Patent Application Publication
(10) Pub. No.: US 2026/0169225 A1
(43) Pub. Date: Jun. 18, 2026

(54) LENS-TYPE TOTAL REFLECTION WAVELENGTH DIVISION MULTIPLEXING PASSIVE ELEMENT STRUCTURE

(71) Applicant: FOCI FIBER OPTIC COMMUNICATIONS, INC., HSINCHU (TW)

(72) Inventors: Ting-Ta Hu, HSINCHU (TW); Po-Yi Wu, HSINCHU (TW); Chieh-Yu Fang, HSINCHU (TW); Ting-Yan Lin, HSINCHU (TW); Tse-Fu Chang, HSINCHU (TW)

(21) Appl. No.: 19/032,183

(22) Filed: Jan. 20, 2025

(30) Foreign Application Priority Data
Dec. 17, 2024 (TW) 113149168

(51) Int. Cl. G02B 6/293; G02B 6/32

(52) U.S. Cl. CPC G02B 6/2938; G02B 6/32

(57) ABSTRACT

The invention relates to a lens-type total reflection wavelength division multiplexing passive element structure. The structure involves a body, having a first side and a second side arranged oppositely; a lens set, arranged on the first side of the body; a total reflection film, provided on the first side of the body and located below the lens set; a plurality of bandpass filters, arranged in parallel up and down on the second side of the body, and each bandpass filter allowing light waves of different wavelengths to pass through; and a triangular prism, provided on the second side of the body and covering the bandpass filters, with a vertical side of the triangular prism s attached to the second side of the body; wherein, the light waves passing through the corresponding bandpass filters undergo total reflection through the triangular prism to output light waves of different wavelengths respectively.

### BACKGROUND OF THE INVENTION

### 1. Field of the Invention

The present invention relates generally to the technical field of wavelength division multiplexing, and more particularly, to a lens-type total reflection wavelength demultiplexing passive element structure that utilizes bandpass filters to allow light waves of specific wavelengths to pass through and utilizes total reflection to form a vertical Z-shaped light splitting path.

### 2. The Prior Arts

Wavelength Division Multiplexing (WDM) technology is to synchronously transmit multiple light waves of different wavelengths within a single optical fiber, doubling the data transmission speed and capacity. Afterwards, multiple light waves of different wavelengths are transmitted to different devices to separate and output signals of different wavelengths.

FIG. 1 is a schematic view of a conventional wavelength demultiplexer. The conventional wavelength demultiplexer 10′ may include an incident light collimating module 100′, a packaging box 200′, a first lens 300′, a glass block 400′, and a plurality of optical filters 510′-540′, a second lens 600′, a light output collimation module 700′, and a plurality of optical fibers 810′-840′; the first lens 300′, the glass block 400′, the filters 510′-540′, the second lens 600′, and the light output collimation module 700′ can be arranged in the packaging box 200′. The incident light collimating module 100′ can emit a light beam R′ to the first lens 300′ and then to the first area 411′ (with anti-reflection film) of the glass block 400′ facing the first side 410′ of the first lens 300′, and since the glass block 400′ is a parallelogram, and the filter 510′ is disposed on a second side 420′ of the glass block 400′ away from the first lens 300′, therefore, the light waves of specific wavelengths in the light beam can pass through one of the filters 510′ and be transmitted through, while the light waves of other wavelengths are reflected back to the second area 412′ of the first side 410′ of the glass block 400′ by the filter 510′. On the second area 412′, due to the high Reflectivity film, so light waves of other wavelengths can be reflected back to the second side 420′, and so on to separate the light beam into light waves W1′-W4′ of different wavelengths, and the light waves W1′-W4′ pass through the second lens 600′ to the light output collimation module 700′, and then correspondingly transmitted to different optical fibers 810′-840′.

The conventional wavelength demultiplexer 10′ of the aforementioned FIG. 1 adopts a horizontal Z-shaped sequential light splitting mode, and cannot change the travel direction of the light wave or beam, such as a 90-degree turn; furthermore, the conventional input beam of the wavelength demultiplexer 10′ is only a single beam and its size is too large and the number of channels is not large, so it cannot transmit light wave signals of multiple different beams at the same time; furthermore, in the packaging operation of silicon photonics, the conventional structure is too complex and the light waves are prone to loss after being converted by too many components, causing the transmission energy and signals to be easily interfered by noise or the signal is unclear.

### SUMMARY OF THE INVENTION

A primary objective of the present invention is to provide a lens-type total reflection wavelength division multiplexing passive element structure, which utilizes a bandpass filter to allow light waves of specific wavelengths to pass through and utilizes total reflection to form a vertical Z-shaped light splitting path, so as to simplify component configuration, reduce attenuation and loss of light wave energy, thereby achieving light steering, suitable for silicon photonics packaging operations, for example, co-packaged optical components (CPO) technology, and avoid signal interference by noise or unclear signal.

To achieve the aforementioned objective, the present invention provides a lens-type total reflection wavelength division multiplexing passive element structure, including a body, having a first side and a second side arranged oppositely; a lens set, disposed on the on the first side of the body; a total reflection film, disposed on the first side of the body and located below the lens set; a plurality of bandpass filters, disposed in parallel up and down on the second side of the body, with each band-pass filter allowing light waves of different wavelengths to pass through; and a triangular prism, disposed on the second side of the body and covering the bandpass filters, with a vertical side of the triangular prism attached to the second side of the body; wherein, the light waves passing through the corresponding bandpass filters undergo total reflection through an oblique side of the triangular prism and are turned to a bottom side of the triangular prism to convert light waves of different wavelengths for outputting separately.

In some embodiments, the lens set includes a plurality of lenses arranged side by side on the first side of the body.

In some embodiments, the lens-type total reflection wavelength division multiplexing passive element structure also includes an optical fiber array corresponding to the lens set and spaced apart from each other.

In some embodiments, the optical fiber array includes a plurality of optical fibers, and each optical fiber is disposed correspondingly to a lens.

In some embodiments, an optical axis of each lens of the lens set is parallel to or overlaps with a horizontal line, and a long axis of each optical fiber of the optical fiber array overlaps with the optical axis of each lens of the corresponding lens set.

In some embodiments, an optical axis of each lens of the lens set forms an angle with a horizontal line, and a long axis of each optical fiber of the optical fiber array overlaps with the optical axis of each lens of the corresponding lens set.

In some embodiments, the body is disposed on a surface of one end of a carrier plate.

In some embodiments, the optical fiber array is disposed on the surface of the carrier plate.

In some embodiments, the body is made of a transparent material.

Compared with the known technology, the lens-type total reflection wavelength division multiplexing passive element structure of the present invention is relatively streamlined, allowing light waves to pass through fewer components to reduce the loss caused by conversion, so each light wave signal is not easily interfered by noise, or becomes unclear, and this structure can also transmit light wave signals of multiple different beams, thereby meeting the signal transmission required by the silicon photonic packaging structure and meeting the needs of today's such products.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic view of a conventional wavelength demultiplexer.

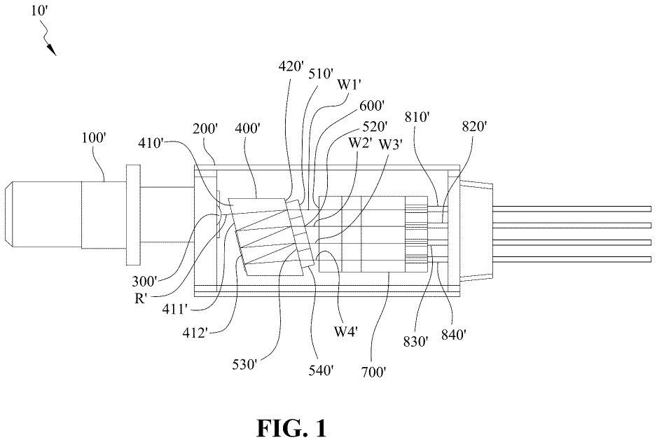

FIG. 2 is a schematic side view of the first embodiment of the lens-type total reflection wavelength division multiplexing passive element structure of the present invention.

FIG. 3 is a schematic side view of the first embodiment of the lens-type total reflection wavelength division multiplexing passive element structure of the present invention combined with the light wave path.

FIG. 4 is a schematic side view of the first embodiment of the lens-type total reflection wavelength division multiplexing passive element structure of the present invention combined with a carrier plate and an optical fiber array.

FIG. 5 is a schematic perspective view of the first embodiment of the of the present invention combined with a carrier plate and an optical fiber array.

FIG. 6 is a schematic side view of the second embodiment of the lens-type total reflection wavelength division multiplexing passive element structure of the present invention.

FIG. 7 is a schematic perspective view of the second embodiment of the of the present invention.

### DETAILED DESCRIPTION OF THE PREFERRED EMBODIMENT

The technical solutions of the present invention will be described clearly and completely below in conjunction with the specific embodiments and the accompanying drawings. It should be noted that when an element is referred to as being “mounted or fixed to” another element, it means that the element can be directly on the other element or an intervening element may also be present. When an element is referred to as being “connected” to another element, it means that the element can be directly connected to the other element or intervening elements may also be present. In the illustrated embodiment, the directions indicated up, down, left, right, front and back, etc. are relative, and are used to explain that the structures and movements of the various components in this case are relative. These representations are appropriate when the components are in the positions shown in the figures. However, if the description of the positions of elements changes, it is believed that these representations will change accordingly.

Unless otherwise defined, all technical and scientific terms used herein have the same meaning as commonly understood by one of ordinary skill in the art of the present invention. The terminology used herein is for the purpose of describing particular embodiments only and is not intended to limit the present invention. As used herein, the term “and/or” includes any and all combinations of one or more of the associated listed items.

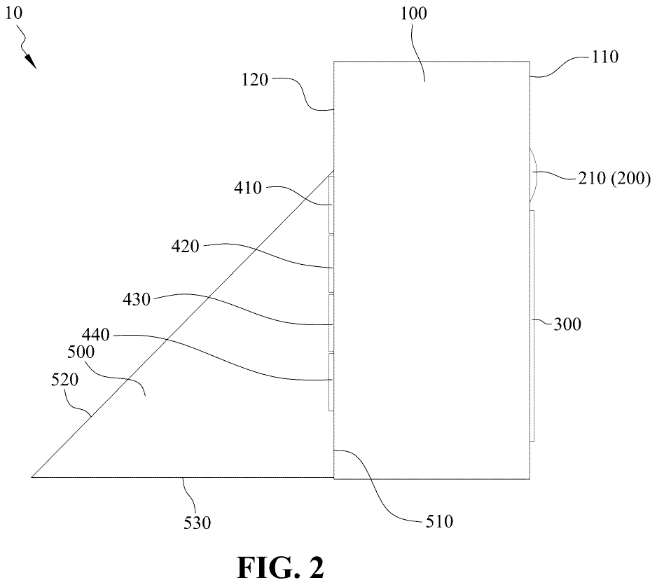

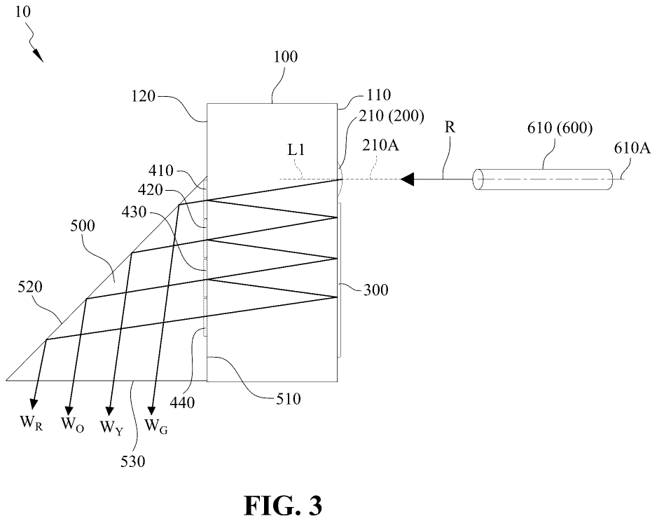

FIG. 2 is a schematic side view of the first embodiment of the lens-type total reflection wavelength division multiplexing passive element structure of the present invention. FIG. 3 is a schematic side view of the first embodiment of the lens-type total reflection wavelength division multiplexing passive element structure of the present invention combined with the light wave path.

Refer to FIGS. 2 and 3. The lens-type total reflection wavelength division multiplexing passive element structure 10 of the first embodiment of the present invention includes a body 100, a lens set 200, a total reflection film 300, and a plurality of bandpass filters, such as bandpass filters 410, 420, 430, 440, and a triangular prism 500, i.e., a column with a triangular cross-section.

The body 100 has a first side 110 and a second side 120, arranged oppositely. In some embodiments, the body 100 may be made of a transparent material, such as glass, but is not limited thereto.

The lens set 200 may be disposed on the first side 110 of the body 100. In some embodiments, lens set 200 may include a plurality of lenses 210, disposed side by side laterally on the first side 110 of the body 100. In some embodiments, the lens 210 is a convex lens, and a convex surface of the convex lens faces outward.

The total reflection film 300 is disposed on the first side 110 of the body 100 and located below the lens set 200.

The plurality of bandpass filters can be disposed on the second side 120 of the body 100 in parallel, in an up-and-down stack manner. Each bandpass filter can allow light waves of different wavelengths to pass through. In the present embodiment, four bandpass filters 410, 420, 430, and 440 are used as an example for description, but the invention is not limited thereto. As shown in FIG. 3, from top to bottom, there is a bandpass filter 410 that allows a first light wave W_{G} of a first wavelength λ_{G} to pass, and a bandpass filter 420 that allows a second light wave W_{Y} of a second wavelength λ_{Y} to pass, a bandpass filter 430 that allows a third light wave W_{O} of a third wavelength λ_{O} to pass, and a bandpass filter 440 that allows a fourth light wave W_{R} of a fourth wavelength λ_{R} to pass.

The triangular prism 500 is disposed on the second side 120 of the body 100 and cover the bandpass filters 410, 420, 430, and 440. To be more specific, a vertical side 510 of the triangular prism 500 is attached to the second side 120 of the body 100.

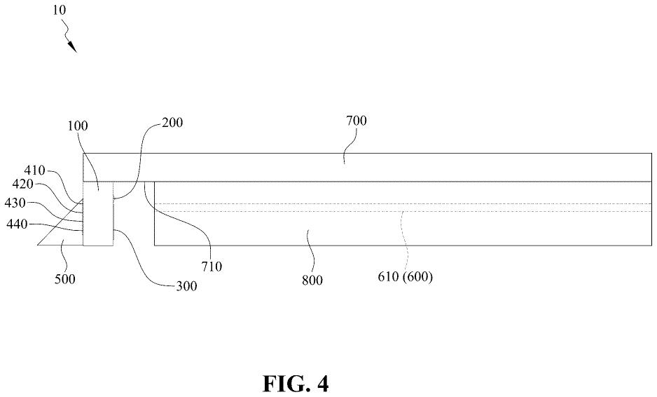

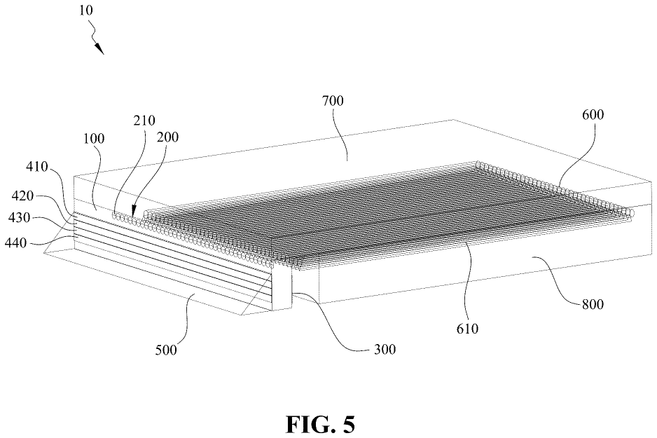

FIG. 4 is a schematic side view of the first embodiment of the lens-type total reflection wavelength division multiplexing passive element structure of the present invention combined with a carrier plate and an optical fiber array. FIG. 5 is a schematic perspective view of the first embodiment of the lens-type total reflection wavelength division multiplexing passive element structure of the present invention combined with a carrier plated and an optical fiber array.

Refer to FIGS. 4 and 5. The lens-type total reflection wavelength division multiplexing passive element structure 10 of the present invention may also include an optical fiber array 600 and a carrier plate 700.

The optical fiber array 600 corresponds to the lens set 200 and is disposed spaced apart from the lens set 200. In some embodiments, the optical fiber array 600 may include a plurality of optical fibers 610. Each optical fiber 610 can be disposed correspondingly to each corresponding lens 210.

The body 100 may be disposed on a surface 710 of one end of the carrier plate 700 (for example, the lower surface in FIG. 4), and the optical fiber array 600 can be disposed on the surface 710 of the carrier plate 700. In some embodiments, the optical fiber array 600 can be disposed on the surface 710 of the carrier plate 700 through a base 800, wherein the base 800 is disposed with a plurality of V-shaped grooves in parallel. Each optical fiber 610 of the optical fiber array 600 can be correspondingly arranged in each V-shaped groove.

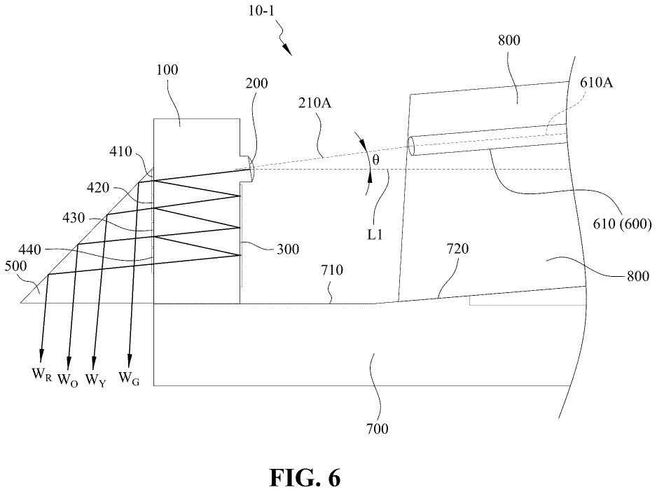

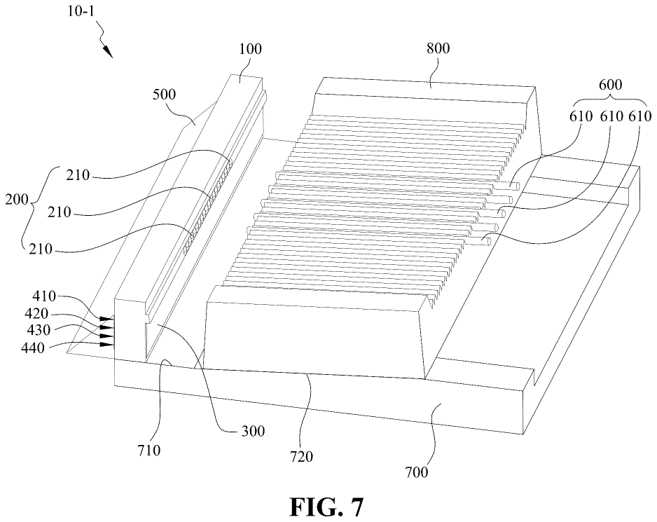

FIG. 6 is a schematic side view of the second embodiment of the lens-type total reflection wavelength division multiplexing passive element structure of the present invention. FIG. 7 is a schematic perspective view of the second embodiment of the lens-type total reflection wavelength division multiplexing passive element structure of the present invention.

Refer to FIG. 3 and FIG. 6. In FIG. 3, an optical axis 210A of each lens 210 of the lens set 200 of the lens-type total reflection wavelength division multiplexing passive element structure 10 of the first embodiment of the present invention can be parallel to or overlap with a horizontal line L1, and a long axis 610A of each optical fiber 610 of the optical fiber array 600 may overlap with the optical axis 210A of each lens 210 of the corresponding lens set 200. In FIG. 6, an optical axis 210A of each lens 210 of the lens set 200 of the lens-type total reflection wavelength division multiplexing passive element structure 10-1 of the second embodiment of the present invention and a horizontal line L1 can form an angle θ, and a long axis 610A of each optical fiber 610 of the optical fiber array 600 can overlap with the optical axis 210A of each lens 210 of the corresponding lens set 200.

Refer to FIG. 7. The body 100 of the lens-type total reflection wavelength division multiplexing passive element structure 10-1 of the second embodiment of the present invention can be disposed on the surface 710 of the carrier plate 700 (for example, the upper surface in FIG. 7), and the carrier plate 700 has a slope 720. The base 800 for the optical fiber array 600 can be disposed on the slope 720, thereby realizing that the optical axis 210A of each lens 210 and the horizontal line L1 can form an angle θ, and the long axis 610A of each optical fiber 610 of the optical fiber array 600 may overlap with the optical axis 210A of each lens 210 of the corresponding lens set 200.

Refer back to FIG. 3. One of the optical fibers 610 of the optical fiber array 600 emits a light beam R to the corresponding lens 210 of the lens set 200. After passing through the body 100, the light beam R passes through the corresponding bandpass filter (such as a bandpass filter 410, 420, 430, 440), and then undergo total reflection through an oblique side 520 of the triangular prism 500 and then turn to a bottom side 530 of the triangular prism 500 to output light waves of different wavelengths respectively, that is, the first light wave W_{G} outputted through the bandpass filter 410, the second light wave W_{Y} outputted through the bandpass filter 420, the third light wave W_{O} outputted through the bandpass filter 430, and the fourth light wave W_{R} outputted through the bandpass filter 440.

In summary, the lens-type total reflection wavelength division multiplexing passive element structure 10, 10-1 of the present invention allows light waves of specific wavelengths (for example, a first light wave W_{G} of a wavelength λ_{G}, a second light wave W_{Y} of a second wavelength λ_{Y}, a third light wave W_{O} of a third wavelength λ_{O}, and a fourth light wave W_{R} of a fourth wavelength λ_{R}) to pass through the bandpass filters 410, 420, 430, 440 respectively and utilizes total reflection to form a vertical Z-shape splitting path (that is, incident from the vertical side 510 of the triangular prism 500, total reflection through the oblique side 520 of the triangular prism 500, and then output from the bottom side 530 of the triangular prism 500) to simply component configuration, reduce the attenuation and loss of light wave energy to achieve light steering, which is suitable for silicon photonic packaging operations and avoids situations where the signal is easily interfered by noise or the signal is unclear.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A lens-type total reflection wavelength division multiplexing passive element structure, comprising:
a body, having a first side and a second side arranged oppositely;
a lens set, disposed on the on the first side of the body;
a total reflection film, disposed on the first side of the body and located below the lens set;
a plurality of bandpass filters, disposed in parallel up and down on the second side of the body, with each band-pass filter allowing light waves of different wavelengths to pass through; and
a triangular prism, disposed on the second side of the body and covering the bandpass filters, with a vertical side of the triangular prism attached to the second side of the body;
wherein, the light waves passing through the corresponding bandpass filters undergo total reflection through an oblique side of the triangular prism and are turned to a bottom side of the triangular prism to convert light waves of different wavelengths for outputting separately.

2. The lens-type total reflection wavelength division multiplexing passive element structure according to claim 1, wherein the lens set includes a plurality of lenses arranged side by side on the first side of the body.

3. The lens-type total reflection wavelength division multiplexing passive element structure according to claim 2, further comprising an optical fiber array, corresponding to the lens set and disposed spaced apart from the lens set.

4. The lens-type total reflection wavelength division multiplexing passive element structure according to claim 3, wherein the optical fiber array comprises a plurality of optical fibers, and each optical fiber is disposed correspondingly to a lens.

5. The lens-type total reflection wavelength division multiplexing passive element structure according to claim 4, wherein an optical axis of each lens of the lens set is parallel to or overlaps with a horizontal line, and a long axis of each optical fiber of the optical fiber array overlaps with the optical axis of each lens of the corresponding lens set.

6. The lens-type total reflection wavelength division multiplexing passive element structure according to claim 4, wherein an optical axis of each lens of the lens set forms an angle with a horizontal line, and a long axis of each optical fiber of the optical fiber array overlaps with the optical axis of each lens of the corresponding lens set.

7. The lens-type total reflection wavelength division multiplexing passive element structure according to claim 3, wherein the body is disposed on a surface of one end of a carrier plate.

8. The lens-type total reflection wavelength division multiplexing passive element structure according to claim 7, wherein the optical fiber array is disposed on the surface of the carrier plate.

9. The lens-type total reflection wavelength division multiplexing passive element structure according to claim 1, wherein the body is made of a transparent material.
